(19) United States
(12) Patent Application Publication
(10) Pub. No.: US 2011/0075426 A1
(43) Pub. Date: Mar. 31, 2011

(54) LED ILLUMINATION DEVICE

(76) Inventor: Yen Chi Wu, Sinjhuang City (TW)

(21) Appl. No.: 12/634,105

(22) Filed: Dec. 9, 2009

(30) Foreign Application Priority Data
Sep. 29, 2009 (TW) 098217971

(51) Int. Cl. F21V 29/00

(52) U.S. Cl. 362/294; 362/373

(57) ABSTRACT

An LED lamp illumination device includes an upper lid, an LED illumination module, a lower lid and two side lids. The upper lid is formed with a top surface and a bottom surface, a plurality of dissipation holes are penetrated the top surface to the bottom surface of the upper lid. The LED illumination module is fixed at the bottom surface of the upper lid. The lower lid is covered with the bottom surface of the upper lid to encapsulate the LED illumination module, wherein the lower lid is formed with an illumination hole corresponds to the LED illumination module. And two side lids are covered at the two sides of the upper lid and the lower lid.

### BACKGROUND OF THE INVENTION

1. Field of the Invention

The present invention relates to an LED illumination device, and in particular to an LED illumination capable of assembling more easily and decreasing the cost of the manufacture.

2. Description of the Related Art

Please referring to FIG. 1, an explosion view of the traditional daylight lamp includes lamp tube 100 and lamp base 200, The lamp tube 100 has a body 110 and a metal end 120, which has an electrode connection 130. The lamp base 200 has a lamp body 210, electrode base 220 and a starter 230. The electrode base 220 is arranged at the two side of the lamp body 210, and formed with electrode hole 240.

Since light emitting diodes (LEDs) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout or different projecting areas, so as to differentiate the projecting area for each LED Lamp with a different distance from the LED lamp and the projecting area, and prevent an uneven brightness of the light projected from the LED lamps onto the projecting areas. Therefore, it is an important subject for manufacturers in the related field to design an LED tamp with good directionality and even brightness.

As is generally known in the art, use has been made of varying kinds of illumination lamps for lightening or illuminating objects at night or indoors. Such illumination lamps arc supplied with electric energy from a power source and convert the electric energy to light energy, thereby producing a beam of light for illumination. Typical examples of the illumination lamps include a glow lamp and a fluorescent lamp.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp.

### SUMMARY OF THE INVENTION

An object of the present invention is to provide an LED illumination device capable of assembling easily to reduce the assembling cost.

An object of the present invention is to provide an LED illumination device capable of providing best heat dissipation.

To achieve the above-mentioned object, the present invention includes an upper lid, an LED illumination module, a lower lid and two side lids. The upper lid is formed with a top surface and a bottom surface, a plurality of dissipation holes are penetrated the top surface to the bottom surface of the upper lid. An LED illumination module is fixed at the bottom surface of the upper lid. The lower lid is covered with the bottom surface of the upper lid to encapsulate the LED illumination module, wherein the lower lid is formed with an illumination hole corresponds to the LED illumination module. And two side lids are covered at the two sides of the upper lid and the lower lid.

### BRIEF DESCRIPTION OF THE DRAWINGS

FIG. 1 is an exploded view of a traditional daylight lamp.

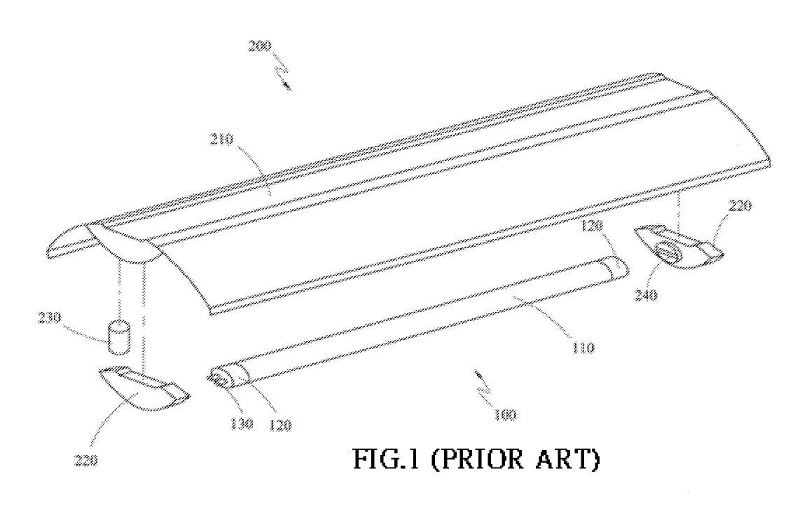

FIG. 2 is an exploded view of LED illumination device of the present invention

FIG. 3A is as assembly drawing of the FIG. 2.

FIG. 3B is a bottom view of assembly drawing of the FIG. 2.

FIG. 4 is a cross-sectional view of the FIG. 3A.

### DETAILED DESCRIPTION OF THE INVENTION

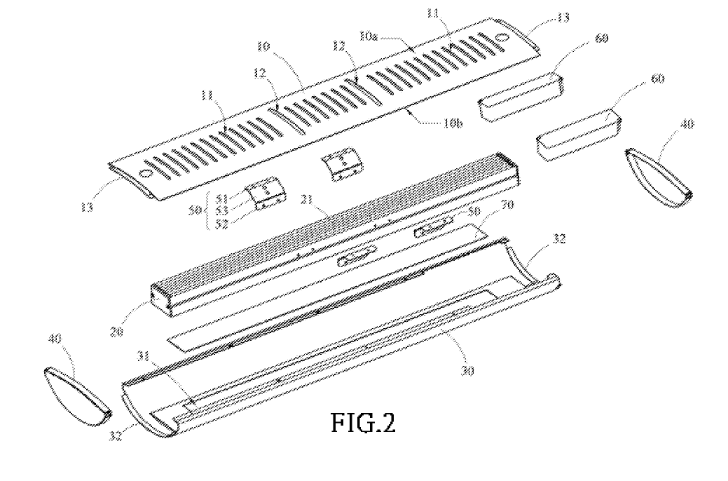

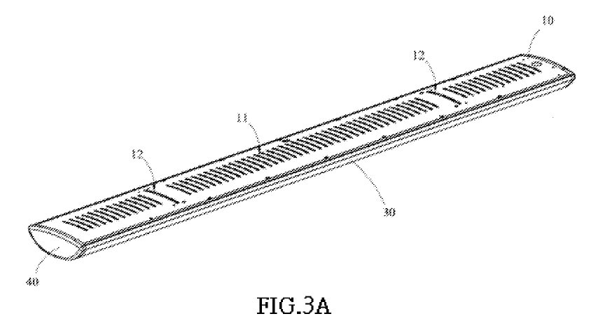

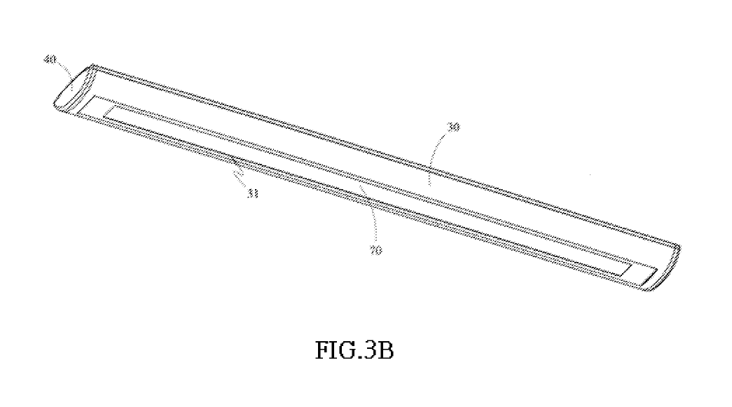

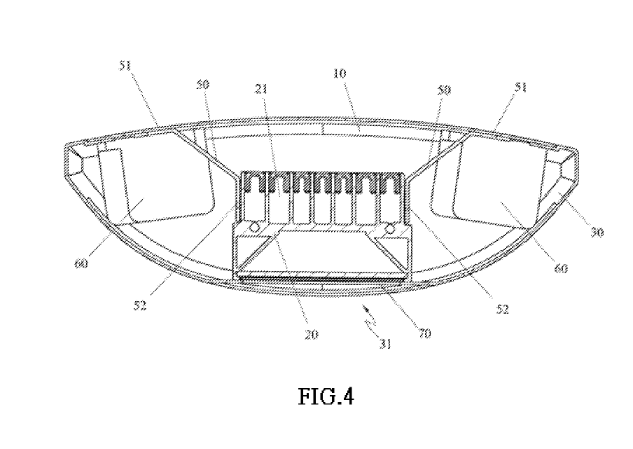

Referring to FIG. 2-FIG. 4, an LED illumination device of the present invention includes an upper lid 10, an LED illumination module 20, lower lid 30, two side lids 40, two fixed sheet 50, a voltage transformer 60 and a transparent sheet 70.

The upper lid 10 is formed with top surface 10a and a bottom surface 10b, a plurality of heal dissipation holes 11 are penetrated the top surface 10a to the bottom surface 10b of the upper lid 10.

The LED illumination module 20 is fixed at the bottom surface 10b of the upper lid 10, in the preferred embodiment, the LED illumination module 20 has a heat sink 21, which is fixed at the bottom surface 10b of the upper lid 10 through the two fixed sheet 50.

The fixed sheet 50 has a first portion 51, which is fixed at the upper lid 10 and a second portion 52, which is fixed at the heat sink 21 of the LED illumination module 20, the first portion 51 of the fixed sheet 50 is connected to the second portion 52 of the fixed sheet through the third portion 53.

The lower lid 30 is covered with the bottom surface 10b of the upper lid 10 to encapsulate the LED illumination module 20, wherein the lower lid 30 is formed with a illumination hole 31 correspond to the LED illumination module 20;

The two side lids 40 are covered at the two sides of the upper lid 10 and the lower lid 30.

The voltage transformer 60 is arranged at the bottom surface 11b of the upper lid 10 to electrically connect the LED illumination module 20. And

The transparent sheet 70 is arranged at the illumination hole 31 of the lower lid 30.

Therefore, according to the above-mentioned structure, after the LED illumination device has been assembled, the LED illumination module may efficient heat dissipation through the heat sink 21 and heat dissipation holes 11 of the upper lid 10, and may through light by the illumination hole 31.

While the present has been described by way of an example and in terms of a preferred embodiment, it is to he understood that the invention is not limited to the disclosed embodiment. To the contrary, it is intended to cover various modifications. Therefore, the scope of the appended claims should be accorded the broadest interpretation so as to encompass all such modification.

What is claimed is:

1. An LED illumination device comprising
An upper lid formed with a top surface and a bottom surface, a plurality of heat dissipation holes penetrated the top surface to the bottom surface of the upper lid;
An LED illumination module fixed at the bottom surface of the upper lid;
A lower lid covered with the bottom surface of the upper lid to encapsulate the LED illumination module, wherein the lower lid is formed with an illumination bole corresponds to the LED illumination module; and
Two side lids covered at the two sides of the upper lid and the lower lid.

2. The LED illumination device according to claim 1, further comprising at least two fixed sheets, each of sheet has a first portion, which is fixed at the upper lid and second portion, which is fixed at the LED illumination module.

3. The LED illumination device according to claim 1, further comprising a transparent sheet, which is covered at the illumination hole.

4. The LED lamp illumination device according to claim 1, further comprising a voltage transformer arranged at the bottom surface of the upper lid to electrically connect the LED illumination module.

5. The LED lamp illumination device according to claim 1, further comprising a heat sink, wherein the LED illumination module is mounted on the heat sink.
